(19) United States
(12) Patent Application Publication
(10) Pub. No.: US 2013/0113376 A1
(43) Pub. Date: May 9, 2013

(54) PHOTOVOLTAIC MODULE

(71) Applicant: Chao Hsiang LU, Kaohsiung (TW)

(72) Inventor: Chao Hsiang LU, Kaohsiung (TW)

(21) Appl. No.: 13/292,139

(22) Filed: Nov. 9, 2011

(51) Int. Cl. H05B 37/02

(52) U.S. Cl. 315/86; 315/307

(57) ABSTRACT

A solar photovoltaic module includes a solar panel that generates solar power, a light-emitting diode (LED), and a micro-chip unit that is electrically coupled between the solar panel and the LED, and detects the solar power, calculates a match relation between the solar power and consumption power of the LED, and distributing the solar power to the LED according to the match relation. Therefore, the LED may emit light all night long or during all predetermined periods, and have its flashlight types and intensity be set by software.

### BACKGROUND OF THE INVENTION

1. Field of the Invention

This invention relates to photovoltaic modules, and, more particularly, to a solar photovoltaic module in which a solar panel generates solar power and evenly distributes the solar power to all the light-emitting periods of a light emitting diode.

2. Description of Related Art

Generally, a solar power system has a light emitting diode (LED) that has its intensity being stationary or manually adjusted. However, the intensity of these two types of LEDs cannot be monitored or set by software automatically. In consequence, the solar power system encounters some problems as follows.

1. No matter how great the solar power that the solar panel generates during the day, the LED emits light of constant intensity during the night (i.e., consuming the same power every night). Even if it is cloudy and the solar panel generates less solar power (i.e., less than the solar power generated by the solar panel during a sunny day), the LED still emits light of constant intensity during the night. Accordingly, the LED may consume the backup power. When it becomes clear again, the solar power generated by the solar panel will not only be supplied to the LED for the LED to emit light of constant intensity, but also be provided to the backup power. However, the solar power provided to the backup power is not enough all the time. Therefore, the backup power may be used up gradually, and the LED can emit light only three to five hours at night or during a portion of the night period, or cannot emit any light after a couple of days.

2. According to the manual for adjusting flashlight types of an LED in a solar power system, the intensity of an LED cannot be set by software. A professional person has to first select a flashlight type for the LED, and then calculate and set the intensity of the LED according to the solar power generated by the solar panel. In general, the LED has only four levels of intensity, and the solar power generated by the solar panel cannot be applied to an LED that emit light of as many as 256 flashlight types.

### SUMMARY OF THE INVENTION

In view of the above-mentioned problems of the prior art, that are the LED has its intensity being stationary or manually adjusted, the LED cannot emit light all night long or during all predetermined periods (flashlight), and the flashlight types and intensity of the LED cannot be set by software, it is a primary objective of the present invention to provide a solar photovoltaic module, in which a micro-chip unit enables an LED to emit light all night long and sets the flashlight types and intensity of the LED.

In an embodiment, the solar photovoltaic module includes a solar panel that generates solar power, a light emitting diode (LED), and a micro-chip unit (MCU) electrically coupled between the solar panel and the LED for detecting the solar power and calculating a match relation between the solar power and consumption power of the LED, so as to distribute the solar power to the LED according to the match relation.

In another embodiment, the MCU adjusts the flashlight types of the LED according to a flashlight type adjustment manual, and the solar photovoltaic module further includes a wireless (IrDA) remote controller that changes intensity or flashlight types of the LED, sets the LED to emit light of less intensity, or disables the MCU to detect the solar power; an analog-to-digital converter (ADC) and a drive integrated circuit (IC), wherein the ADC is electrically coupled between the solar panel and the MCU for converting analog signals of the solar power into digital signals and transmitting the digital signals to the MCU, and the drive IC is electrically coupled between the LED and the MCU for receiving drive signals output by the MCU according to the digital signals and driving the LED to consume power according to the drive signals; and backup power, wherein the backup power is supplied to the LED when the MCU detects that the solar power is not enough to enable the LED to emit light, and the solar power is provided to the backup power when the MCU detects that the backup power is not at a greatest predetermined voltage value.

Compared to the prior art, the solar photovoltaic module of the present invention comprises an MCU that controls an LED to emit light all night long or during all predetermined periods (flashlight) even if it is cloudy or solar power generated by a solar panel is insufficient, and supplies all or a portion of the solar power to backup power, so as to prevent the backup power from being less than a least predetermined voltage value and ensure the solar photovoltaic module to operate normally.

### BRIEF DESCRIPTION OF DRAWINGS

No figure is provided.

### DETAILED DESCRIPTION OF THE INVENTION

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

In the present invention, a micro-chip unit (MCU) calculates a match relation between solar power generated by a solar panel and consumption power of a light emitting diode (LED). The greater the solar power is, the lighter the LED becomes, or the dimmer of the light emitted by the LED is, without consuming the backup power.

In an embodiment of the present invention, the intensity of the light emitting by the LED is divided into 255 levels. If it is sunny, the light emitted by the LED has great intensity at night, or the LED emits light of less intensity. Accordingly, the MCU calculates the intensity of the LED (i.e., setting the intensity of the LED in one of the 255 levels) according to the solar power generated by the solar panel, so as to prevent from consuming the backup power. If it is cloudy for a couple of days, and the solar power generated by the solar panel is not great enough for the LED to emit light, the MCU supplies the backup power to the LED and enables the LED to emit light of least intensity (e.g., the second level), so as to prevent the LED from consuming too much the backup power. The MCU keeps enabling the LED to emit light of less intensity, until it is sunny and the backup power is at a greatest predetermined voltage value by supplying the solar power generated by the solar panel to the backup power continuously.

In an embodiment of the present invention, the LED has different flashlight types and intermission periods. The longer the intermission periods are, the less the power that the LED consumes becomes. Therefore, the LED consumes different amount of power from day to day or from a period to another period. The MCU sets a number of intensity levels of the LED, and sets the flashlight types and the total consumption power of the LED during a night or a period according to the amount of solar power generated by the solar panel during the day. In consequence, the LED may emit flashlight of better intensity all night long to provide an alarm effect, and the solar power generated during the day may be best distributed.

In an embodiment of the present invention, the flashlight types of the LED may be adjusted by reference to the flashlight type adjustment manual.

For instance, if the LED operates 13 hours at night and emits flashlight every four seconds (emitting light for 0.5 second, and emitting no light for 3.5 seconds), the LED will consume power for 1.625 hours, and consume no power for the remaining 11.375 hours. Alternatively, if the LED operates 13 hours at night and emits flashlight every two seconds (emitting light for one second, emitting no light for one second), the LED will consume power for 6.5 hours, and consume no power for the remaining 6.5 hours. Therefore, the LED, if operating in different flashlight types, has different light-emitting periods (or consumes different amount of power). The MCU sets the LED to emit light of different number of intensity levels according to the solar power generated by the solar panel. For instance, a one-watt solar panel is divided into 18 intensity levels of the LED, a two-watt solar panel is divided into 26 intensity levels of the LED, a three-watt solar panel is divided into 30 intensity levels of the LED, a four-watt solar panel is divided into 36 intensity levels of the LED, and a five-watt solar panel is divided into 42 intensity levels of the LED. Likewise, a 100-watt solar panel may be divided into a predetermine number intensity levels of the LED. If an aviation or navigation LED is set to emit light for 13 hours at night, and the solar panel generates the solar power four hours a day, the greatest solar power generated by a five-watt solar panel is 5×4=20 watts hours (the above data may adjusted on demands), and the LED may have 42 intensity levels according to the flashlight type adjustment manual, wherein the 9^{th} intensity level is 1.53 watts×13 hours, the 0^{th} intensity level is 1.66 watts×12 hours, the 1^{st} intensity level is 1.82 watts×11 hours, the 2^{nd} intensity level is 2 watts ×10 hours, the 3^{rd} intensity level is 2.22 watts×9 hours, the 4^{th} intensity level is 2.35 watts×8.5 hours, the 5^{th} intensity level is 2.5 watts×8 hours, the 15^{th} intensity level is 5.71 watts×3.5 hours, the 16^{th} intensity level is 6.66 watts×3 hours, the 17^{th} intensity level is 7.4 watts×2.7 hours, the 18^{th} intensity level is 8.33 watts×2.4 hours, the 19^{th} intensity level is 10 watts×2 hours, and the 20^{th} intensity level is 11.1 watts×1.8 hours. The above 21 intensity levels are predetermined values when the backup power is fully loaded. However, when the backup power is not fully loaded the above 21 intensity levels are replaced with the following 21 backup intensity levels, which are three fourths of the above 21 intensity levels, respectively, and the remaining one fourth of the solar power is supplied to the backup power, wherein the 21^{st} intensity level is 1.15 watts×13 hours, the 13^{th} intensity level is 1.24 watts×12 hours, the 22^{nd} intensity level is 1.36 watts×11 hours, the 23^{rd} intensity level is 1.5 watts×10 hours, the 24^{st} intensity level is 1.66 watts×9 hours, the 25^{st} intensity level is 1.76 watts×8.5 hours, the 26^{st} intensity level is 1.87 watts×8 hours, the 36^{st} intensity level is 4.28 watts×3.5 hours, the 37^{st} intensity level is 5.0 watts×3 hours, the 38^{st} intensity level is 5.55 watts×2.7 hours, the 39^{st} intensity level is 6.24 watts×2.4 hours, the 40^{st} intensity level is 7.5 watts×2 hours, and the 41^{st} intensity level is 8.32 watts×1.8 hours. The above 42 intensity levels include the predetermined values and backup values of the LED, and are written in the read-only memory of the MCU in advance. Different flashlight types may have different predetermined intensity values. Solar panels of different watts may supply different solar power to LEDs of different intensity levels. The above predetermined values allow the solar power generated by the solar panel at daytime to be consumed by the LED of 256 flashlight types completely. Therefore, the solar power generated by the solar panel may be consumed effectively.

A wireless (IrDA) remote controller may set the flashlight types of the LED. In an embodiment of the present invention, the wireless (IrDA) remote controller may change intensity or flashlight types of the LED, set the LED to emit light of less intensity, or disable the MCU to detect the solar power. The MCU also detects whether the backup power has the greatest predetermined voltage value, and determines as to whether all or only three fourths of the solar power generated by the solar panel should be supplied to the LED. If the backup power has the greatest predetermined voltage value, the MCU supplies all the solar power to the LED, or only three of fourths of the solar power will be supplied to the LED and the remaining one fourth of the solar power will be provided to the backup power. Therefore, the present invention may set the flashlight type and intensity of the LED in one step, omitting the two steps and complicated power calculation of the prior art.

For instance, according to the flashlight type adjustment manual a two-watt solar LED (aviation or navigation alarm lamp) has the greatest predetermined voltage value equal to 4.2 volts, and the least predetermined voltage level equal to 3.3 volts. When the backup power is less than 4.2 volts, the MCU will supplies one fourth of the solar power (i.e., 8 watts×0.25=2 watts) generated by the solar panel to the backup power, and the LED consumes only three fourths of the solar power (i.e., 8 watts×0.75=6 watts) during that night. The LED is set to operate 13 hours at night, and the solar panel generates the solar power four hours a day, which are adjustable and stored in the read-only memory of the MCU. The solar panel has the greatest solar power equal to 2 watts×4 hours=8 watts hours, and the LED may thus have 26 intensity levels according to the flashlight type adjustment manual, wherein the 9^{th} intensity level is 0.61 watts×13 hours, the 0^{th} intensity level is 0.72 watts×11 hours, the 1^{st} intensity level is 0.8 watts×10 hours, the 2^{nd} intensity level is 0.88 watts×9 hours, the 3^{rd} intensity level is 1.14 watts×7 hours, the 4^{th} intensity level is 1.33 watts×6 hours, the 5^{th} intensity level is 1.6 watts×5 hours, the 6^{th} intensity level is 2 watts×4 hours, the 7^{th} intensity level is 2.28 watts ×3.5 hours, the 8^{th} intensity level is 2.66 watts×3 hours, the 10^{th} intensity level is 2.96 watts×2.7 hours, the 11^{th} intensity level is 3.33 watts×2.4 hours and the 12^{th} intensity level is 3.8 watts×2.1 hours. The above 13 intensity levels are predetermined values when the backup power is fully loaded. However, when the backup power is not fully loaded, the above 13 intensity levels are replaced with the following 13 invention levels, which are backup values of the LED and are equal to three fourths of the above intensity levels, respectively, and the remaining one fourth of the solar power is supplied to the backup power, wherein the 22^{nd} intensity level is 0.45 watts×13 hours, the 13^{th} intensity level is 0.54 watts×11 hours, the 14^{th} intensity level is 0.6 watts×10 hours, the 15^{th} intensity level is 0.66 watts×9 hours, the 16^{th} intensity level is 0.86 watts×7 hours, the 17^{th} intensity level is 0.99 watts×6 hours, the 18^{th} intensity level is 1.2 watts×5 hours, the 19^{th} intensity level is 1.5 watts×4 hours, the 20^{th} intensity level is 1.71 watts×3.5 hours, the 21^{st} intensity level is 1.99 watts×3 hours, the 23^{rd} intensity level is 2.22 watts×2.7 hours, the 24^{th} intensity level is 2.49 watts×2.4 hours, and the 25^{th} intensity level is 2.85 watts×2.1 hours. The above 26 intensity levels include the predetermined values and the backup values of the LED, and can be written in the read-only memory in advance.

According to the variety of flashlight types, the LED may have different intensity levels. For instance, the wireless (IrDA) remote controller is used to select a desire flashlight type, for example emitting light every four seconds (emitting light for 0.5 second, and emitting no light for 3.5 seconds), like a program code 060 in a flashlight number table set by the wireless (IrDA) remote controller, and the MCU sets the LED, according to the predetermined values, to operate in the 12^{th} intensity level (i.e., 3.8 watts×2.1 hours). The MCU thus has a predetermined intensity value equal to 12 and 66.4 cd intensity by looking up a red LED (by reference to DH-130S-3nm light characteristic and predetermined intensity description table), and sends signals having a predetermined value equal to 12 to a drive integrated circuit (IC) (H8168) to adjust the intensity of the LED. For another instance, the wireless (IrDA) remote controller is used in advance to select a desired flashlight type, for example emitting light every two seconds (emitting light for one second, and emitting no light for one seconds), like a program code 010 in the flashlight number table set by the wireless (IrDA) remote controller, and the MCU sets the LED, according to the predetermined values, to operate in the 3^{rd} intensity level (i.e., 1.14 watts×7 hours). The MCU thus has a predetermined intensity value equal to 03 and 20.3 cd intensity by looking up a red LED (by reference to DH-130S-3 nm light characteristic and predetermined intensity description table), and sends signals having a predetermined value equal to 03 to a drive integrated circuit (IC) (H81681) to adjust the intensity of the LED. The above settings may be completed by the wireless (IrDA) remote controller in only one step. In other words, after the flashlight type is selected the LED may have its intensity level set automatically according to the predetermined value, and the intensity level does not change unless that the solar power generated by the solar panel is not great enough for the LED to emit light of the intensity level, until then the MCU will send backup value signals to the drive IC (H8168) to adjust the intensity level of the LED. Since the solar power will generate different amount of solar power when it is sunny or cloudy, the MCU may detect the solar power generated by the solar panel automatically, and the ADC will convert analog signals of the solar power into digital signals. If the flashlight type indicates emitting light every four seconds (emitting light for 0.5 second, and emitting no light for 3.5 seconds), like the program code 060 in the flashlight number table, and the MCU detects that the solar power is eight watts, the MCU detects whether the backup power is fully loaded (a voltage equal to 4.2 volts). If the backup power is 4.2 volts, the MCU sends signals having the predetermined value equal to 12 to the drive IC (H8168) to adjust the intensity level of the LED. The predetermined intensity value of the MCU is 12, which corresponds to consumption power equal to 3.8 watts×1.63 hours=6.19 watts, which identifies that the solar power generated by the solar panel at daytime is equal to 8 watts, and the power consumed by the LED at night is equal to 6.19 watts, such that the backup power will not be supplied to the LED because 8 watts −6.19 watts−1.81 watts, which is greater than zero. Accordingly, the LED may operate normally every night.

When it is cloudy for a couple of days and the solar panel generates less or even no solar power, if the flashlight type indicates emitting light every two seconds (emitting light for one second, and emitting no light for one second), the LED consume power for only 6.5 hours during a 13-hour period. Like a program code 001 in the flashlight number table, the MCU has a predetermined intensity value equal to 03. When the MCU detects that the solar power is equal to 2 watts, the MCU first detects whether the backup power is fully loaded (a voltage equal to 4.2 volts). If the backup power is less than 4.2 volts, the MCU sends signals of backup value equal to 16 to the drive IC (H8168) to adjust the intensity level of the LED. Accordingly, the consumption power is equal to 0.86 watts×6.5 hours=5.59 watts, and the intensity level of the LED is 15.2 cd (since the 16^{th} intensity level (consumption power) is three fourths of the predetermined value. Because 2 watts −5.59 watts=−3.59 watts, which is less than zero, the backup power will be supplied to the LED. After a couple of cloudy days, when the backup power is less than a predetermined 3.3 volts (a general battery is easily malfunctioned if the voltage drops to two volts) the MCU sends a signal 0 indicating too low the voltage to the drive IC (H8168) to turn off the drive IC. Accordingly, the LED does not emit flashlight, and the whole system enters a standby mode, until the backup power is recharged to be greater than 3.8 volts, until then, the MCU sends a signal 1 indicating the voltage is normal to the drive IC and turn on the drive IC again. The LED can then operate normally again. When it is clear again, if the MCU detects that the solar power is equal to 2 watts×4 hours=8 watts hours, the MCU will detect whether the backup power is fully loaded (a voltage of 4.2 volts). If the backup power is less than 4.2 volts, the MCU supplies one fourth of the solar power (i.e., 8×0.25=2 watts) to the backup power, and the LED consumes three fourths of the solar power (8×0.75=6 watts) at that night. Accordingly, the MCU selects the 16^{th} intensity level (0.86 watts×7 hours), and sends a backup value 16 to the drive IC (H8168) to adjust the intensity level of the LED, and the remaining 2.41 watts (8 watts hours−0.86 watts×6.5 hours=2.41 watts) is supplied to the backup power. Likewise, the backup power is supplied with the solar power, and the LED may have the predetermined normal intensity level again when the MCU detects that the backup power is greater than 4.2 volts again.

In an embodiment of the present invention, the 256 flashlight types of the LED may have different combination according to user's demands, and the LED may also have 512 flashlight types. The wireless (IrDA) remote controller may set the flashlight type and intensity of the LED in one step, and the intensity of the LED may change in accordance with the selection of the flashlight type.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A solar photovoltaic module, comprising:
a solar panel that generates solar power;
a light emitting diode (LED); and
a micro-chip unit (MCU) electrically coupled between the solar panel and the LED for detecting the solar power and calculating a match relation between the solar power and consumption power of the LED, so as to distribute the solar power to the LED according to the match relation.

2. The solar photovoltaic module of claim 1, further comprising a wireless (IrDA) remote controller that changes intensity or flashlight types of the LED, sets the LED to emit light of less intensity, or disables the MCU to detect the solar power.

3. The solar photovoltaic module of claim 1, wherein the MCU sets the consumption power of the LED to have 255 levels.

4. The solar photovoltaic module of claim 1, wherein the MCU sets the LED to have a different number of intensity levels according to the solar power.

5. The solar photovoltaic module of claim 4, wherein the LED has light-emitting power equal to 1, 2, 3, 4 or 5 watts, and the MCU sets the LED to have 18, 26, 30, 36 or 42 intensity levels, respectively.

6. The solar photovoltaic module of claim 5, wherein the light-emitting power is 5 watts, the solar panel generate the solar power an average of four hours every day, and the LED emit light 13 hours every night, and wherein, in the 42 intensity levels, the 9^{th} intensity level is 1.53 watts×13 hours, the 0^{th} intensity level is 1.66 watts×12 hours, the 1^{st} intensity level is 1.82 watts×11 hours, the 2^{nd} intensity level is 2 watts×10 hours, the 3^{rd} intensity level is 2.22 watts×9 hours, the 4^{th} intensity level is 2.35 watts×8.5 hours, the 5^{th} intensity level is 2.5 watts×8 hours, the 15^{th} intensity level is 5.71 watts×3.5 hours, the 16^{th} intensity level is 6.66 watts×3 hours, the 17^{th} intensity level is 7.4 watts×2.7 hours, the 18^{th} intensity level is 8.33 watts×2.4 hours, the 19^{th} intensity level is 10 watts×2 hours, and the 20^{th} intensity level is 11.1 watts×1.8 hours.

7. The solar photovoltaic module of claim 6, wherein the MCU comprises a read only memory that has the consumption power stored therein.

8. The solar photovoltaic module of claim 6, further comprises backup power, wherein the backup power is at a greatest predetermined voltage value.

9. The solar photovoltaic module of claim 1, further comprising backup power, wherein the backup power is not at a greatest predetermined voltage value, and one fourth of the light-emitting power is provided to the backup power.

10. The solar photovoltaic module of claim 1, further comprising an analog-to-digital converter (ADC) and a drive integrated circuit (IC), wherein the ADC is electrically coupled between the solar panel and the MCU for converting analog signals of the solar power into digital signals and transmitting the digital signals to the MCU, and the drive IC is electrically coupled between the LED and the MCU for receiving drive signals output by the MCU according to the digital signals and driving the LED to consume power according to the drive signals.

11. The solar photovoltaic module of claim 1, further comprising backup power, wherein the backup power is supplied to the LED when the MCU detects that the solar power is not enough to enable the LED to emit light, and the solar power is provided to the backup power when the MCU detects that the backup power is not at a greatest predetermined voltage value.
